(19) United States
(12) Patent Application Publication
(10) Pub. No.: US 2023/0040705 A1
(43) Pub. Date: Feb. 9, 2023

(54) RISK MANAGEMENT NETWORK

(71) Applicant: Early Warning Services, LLC, Scottsdale, AZ (US)

(72) Inventors: Ravi Loganathan, Charlotte, NC (US); Aniket Panjwani, Scottsdale, AZ (US); Rachael Gwinn, Scottsdale, AZ (US); Ronald Scott Alcorn, Austin, TX (US); Chris Burke, Scottsdale, AZ (US); Jesse Dean, Scottsdale, AZ (US); Deepakshi Aswal, Scottsdale, AZ (US)

(21) Appl. No.: 17/877,423

(22) Filed: Jul. 29, 2022

Related U.S. Application Data
(60) Provisional application No. 63/227,218, filed on Jul. 29, 2021.

(51) Int. Cl. G06Q 40/02

(52) U.S. Cl. CPC G06Q 40/025

(57) ABSTRACT

A method of generating a credit/lending balance sheet may include receiving, from a financial institution, an identifier associated with a request for funds. The method may include identifying one or more financial accounts associated with a debtor who initiated the request for funds based on the identifier. The method may include accessing account data from the one or more financial accounts associated with the debtor. The method may include aggregating the account data from the one or more financial accounts. The method may include generating a balance sheet from the aggregated account data, the balance sheet providing data associated with income and expenses of the debtor.

### CROSS-REFERENCE TO RELATED APPLICATIONS

This application claims the benefit of U.S. Provisional Application Ser. No. 63/227,218, filed Jul. 29, 2021, entitled “RISK MANAGEMENT NETWORK”, the disclosure of which is incorporated by reference herein in its entirety.

### BACKGROUND OF THE INVENTION

Historically, creditors and lenders have relied on credit reporting from established credit bureaus to determine whether a potential debtor is eligible for a given line of credit or loan. However, conventional credit reporting only takes into account past performance of the potential debtor and may insufficiently represent the potential debtor's current creditworthiness. For example, typical credit reporting generates a credit score using a debtor's historical data, such as payment history, credit utilization, average age of credit accounts, and the like. However, such credit reporting fails to consider a debtor's current or recent cash flow or actual ability to make a payment on a loan or credit account. Additionally, traditional credit reporting may be slow to respond to changes in the potential debtor's financial situation. This may lead to financial institutions taking unnecessary risks with a potential debtor who has very recently had a negative change in his financial situation and/or may unfairly punish a potential debtor who has fairly recently had a significant improvement in his financial situation. Thus, there is a need for improved resources for credit and lending decision making.

### BRIEF SUMMARY OF THE INVENTION

Embodiments of the present invention may provide dynamic credit and lending risk measurement tools that may be provided to financial institutions when making credit and lending decisions. Embodiments may include a risk management network that aggregates account data from one or more financial accounts to determine a debtor's ability and/or willingness to repay a given financial obligation. For example, the risk management network may use the account data to generate a balance sheet and/or generate cash flow data that provides an in-depth understanding of the debtor's current financial situation and which may be a better predictor of ability and/or willingness to repay a financial obligation than a conventional credit report.

Some embodiments of the present invention may encompass computerized methods of generating a credit/lending balance sheet. The methods may include receiving, from a requesting financial institution, an identifier associated with a request for funds. The methods may include identifying one or more financial accounts associated with a debtor who initiated the request for funds based on the identifier. The methods may include accessing account data from the one or more financial accounts associated with the debtor. The methods may include aggregating the account data from the one or more financial accounts. The methods may include generating a balance sheet from the aggregated account data. The balance sheet may provide data associated with income and expenses of the debtor.

In some embodiments, the debtor may include an individual or a business entity. The methods may include generating cash flow data associated with the one or more financial accounts. The cash flow data may include one or more financial metrics of the debtor selected from a group consisting of: average monthly expenses, average monthly income, recurring monthly expenses, average monthly balance across the one or more financial accounts, highest monthly balance across the one or more financial accounts, lowest monthly balance across the one or more financial accounts, and average monthly net cash flow across the one or more financial accounts. The methods may include generating a lending score based on the cash flow data. The one or more financial accounts may be maintained by a plurality of financial institutions. The one or more financial accounts may be selected from a group consisting of: a checking account, a savings account, a brokerage account, and a credit card account.

Some embodiments of the present technology may encompass risk management networks. The risk management networks may include one or more processors. The risk management networks may include a memory having instructions stored thereon. When executed, the instructions may cause the one or more processors to receive, from a requesting financial institution, an identifier associated with a request for funds. The instructions may cause the one or more processors to identify one or more financial accounts associated with a debtor who initiated the request for funds based on the identifier. The instructions may cause the one or more processors to access account data from the one or more financial accounts associated with the debtor. The instructions may cause the one or more processors to aggregate the account data from the one or more financial accounts. The instructions may cause the one or more processors to generate a balance sheet from the aggregated account data. The balance sheet may provide data associated with income and expenses of the debtor.

In some embodiments, accessing account data from the one or more financial accounts may include performing an entity resolution process. The instructions may cause the one or more processors to generate cash flow data associated with the one or more financial accounts. The instructions may cause the one or more processors to generate one or more suggested credit lending limits based at least in part on the cashflow data. Generating the one or more suggested credit lending limits may be further based on an average account balance across the one or more financial accounts. Generating the one or more suggested credit lending limits may include generating a plurality of suggested credit limits. Each of the plurality of suggested credit limits may be associated with different lending score. The instructions may cause the one or more processors to provide the one or more suggested credit lending limits to the requesting financial institution. The instructions may cause the one or more processors to generate cash flow data associated with the one or more financial accounts. The instructions may cause the one or more processors to generate a lending score based on the cash flow data. The instructions may cause the one or more processors to provide the lending score to the requesting financial institution.

Some embodiments of the present technology may encompass non-transitory computer-readable mediums having instructions stored thereon. When executed by one or more processors, the instructions may cause the one or more processors to receive, from a requesting financial institution, an identifier associated with a request for funds. The instructions may cause the one or more processors to identify one or more financial accounts associated with a debtor who initiated the request for funds based on the identifier. The instructions may cause the one or more processors to access account data from the one or more financial accounts associated with the debtor. The instructions may cause the one or more processors to aggregate the account data from the one or more financial accounts. The instructions may cause the one or more processors to generate a balance sheet from the aggregated account data. The balance sheet may provide data associated with income and expenses of the debtor.

In some embodiments, the identifier may include personally identifiable information data associated with the debtor. The personally identifiable information data may be used to look up the account data. The instructions may cause the one or more processors to retrieve one or both of income data and expense data from at least one third party data source that is not a financial institution associated with the account data. Aggregating the account data from the one or more financial accounts may include aggregating the one or both of income data and expense data and reconciling the one or both of income data and expense data with the account data to ensure that the one or both of income data and expense data is not doubled counted. The balance sheet may further include the one or both of income data and expense data. The instructions may cause the one or more processors to generate cash flow data associated with the one or more financial accounts. The instructions may cause the one or more processors to identify recurring expenses based on the cash flow data. The instructions may cause the one or more processors to generate a lending score based at least in part on the recurring expenses. The instructions may cause the one or more processors to categorize the expenses into a plurality of categories. Generating the lending score may be based at least in part on the categorized expenses.

### BRIEF DESCRIPTION OF THE DRAWINGS

FIG. 1 illustrates a system for generating credit and lending decisions according to an embodiment of the present invention.

FIG. 2 is a flowchart illustrating a process for generating credit and lending decisions according to an embodiment of the present invention.

FIG. 3 is a flowchart illustrating an entity resolution process according to an embodiment of the present invention.

FIG. 4 is a block diagram of a computing system according to an embodiment of the present invention.

### DETAILED DESCRIPTION OF THE INVENTION

Embodiments of the present invention are directed to techniques for providing enhanced credit and lending information to creditors and lenders. Embodiments may utilize both historical and current payment account information to enable creditors and lender to make more informed decisions as to whether a particular debtor is capable of affording and/or is otherwise a good candidate for a particular loan or line of credit. Embodiments may analyze a particular debtor's cash flow, nature of debits and credits, and/or other data, which may be indicative of consumer distress, recovery, and/or resiliency to support credit and lending than conventional credit reporting. This data may then be used to determine whether the debtor's current financial situation may support the loan or line of credit. In this manner, embodiments of the present invention may provide credit and lending information that may replace and/or supplement credit reporting from established credit bureaus, which may enable financial institutions to make more well informed credit and lending decisions. Embodiments may provide a dynamic approach to credit and lending decisions that reduces the risk and increases the fairness associated with generating such decisions.

Embodiments may include a risk management network that can leverage relationships with a number of financial institutions to access account data from different debtors and/or access account data for multiple accounts across multiple financial institutions for one or more debtors. This account information may be used to generate a balance sheet that illustrates a complete (or largely complete) representation of a debtor's income and expenses. Based on the balance sheet, the risk management network may analyze the cash flow of the debtor over one or more timeframes to better determine whether the debtor is financially situated to pay off a given loan or line of credit and/or otherwise determine a risk of non-repayment associated with the debtor. Additionally, such use of cashflow data associated with one or more accounts of a given debtor may be particularly beneficial for analyzing the risk associated with debtors that do not have (or do not exclusively have) conventional payroll income, such as users who have their own businesses and/or do occasional/seasonal work. In some embodiments, this analysis may include generating a risk score based on the balance sheet data. This risk score may then be provided to a requesting financial institution, which may utilize the risk score in making a determination of whether to extend a given type of credit to a particular debtor.

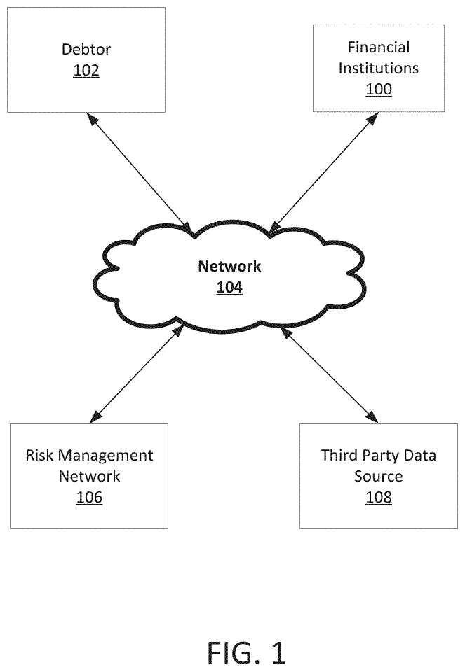

Turning now to FIG. 1, a system for performing credit and lending risk determinations is illustrated. The system may include one or more financial institutions 100. The financial institutions 100 may be banks, credit unions, brokerage firms, credit card issuers, and/or other entities that service financial accounts for consumers and/or businesses. Financial institutions 100 may also encompass other entities that may lend, extend a line of credit, and/or otherwise offer financing options. Each financial institution 100 may include one or more computing systems that facilitate interactions with users and/or back-end systems. The financial institutions 100 may each maintain records not only of balances associated with each account, but may also maintain records of transactions (e.g., debits and credits) associated with the various accounts. Oftentimes, each transaction will include one or more identifiers that may indicate a source of incoming funds, a destination for a payment out of the account, and/or an identifier that is indicative of a category for the transaction (type of expense, payroll deposit, transfer, etc.).

The system may include a number of debtors 102 (including potential debtors) that may interact with one or more of the financial institutions 100. For example, the debtors 102 may maintain one or more financial accounts (checking accounts, savings accounts, credit card accounts, brokerage accounts, cryptocurrency accounts, etc.) at one or more of the financial institutions 100. Additionally, the debtors 102 may apply for loans, credit accounts, and/or otherwise apply to borrow funds from one or more of the financial institutions 100. The debtors 102 may be individuals and/or business entities. The debtors 102 may interact with the financial institutions 100 in person at brick and mortar locations and/or using one or more user devices that communicate with the financial institutions 100 via one or more wired and/or wireless networks 104. Data transmitted across the networks 104 may be secured using encryption techniques, hypertext transfer protocol secure (HTTPS), secure sockets layer (SSL), transport layer security (TLS), and/or other security protocol. The user devices may include mobile phones, tablet computers, personal computers, e-readers, and the like. In some embodiments, the user devices may include computing devices, such as point of sale devices, that may be positioned at brick-and-mortar locations of a given financial institution 100 and that may be usable by the users to interact with a given financial institution 100. The user devices may access the financial institution 100 via software applications and/or websites that are associated with and/or operated by a given financial institution 100 and that provide user interfaces that enable the users to manage accounts and/or apply for funds from the financial institution 100.

The system may include one or more third party data sources 108. Third party data sources 108 may provide one or more types of data that may or may not be available (or readily identifiable) within account data from the financial institutions 100. For example, the third party data sources 108 may provide information about payroll checks/deposits, rent payments, mortgage payments, utility bill payments, and/or other information. This data may be tagged with a data type that may enable the data to be properly categorized when generating a balance sheet and/or cashflow data. Third party data may be particularly useful for users that do not utilize direct deposit and/or automated bill payment systems, as the ACH data from financial accounts may not provide sufficient information in such cases to properly categorize the credits and/or debits. The third party data sources 108 may include employers, providers and processing entities associated with payroll checks/deposits, rent payments, mortgage payments, utility bill payments, and/or other information. The third party data sources 108 may additionally or alternatively include entities that source data from one or more other entities (such as payroll processors, utility companies, mortgage providers, etc.) and make such data available. Such entities may include financial technology (Fintech) companies and/or banking as a service platforms.

The system may include a risk management network 106, which may be in communication with the financial institutions 100, user devices, third party data sources 108, and/or debtors 102 via the one or more networks 104. The risk management network 106 may generate a balance sheet for one or more debtors 102 that may break down a particular debtor's spending and/or earning patterns. For example, the risk management network 106 may establish relationships with any number of financial institutions 100, which may enable the risk management network 106 to access detailed account data associated with financial accounts for numerous debtors 102, as well as financial accounts for a given debtor 102 across multiple financial institutions 100. For example, when a financial institution 100 receives a lending/credit request from a debtor 102, the financial institution 100 may reach out to the risk management network 106 for information related to the particular debtor's ability to repay an amount associated with the lending/credit request. The risk management network 106 may leverage its relationships with the various financial institutions 100 to identify one or more financial accounts (at one or more of the financial institutions 100) associated with the debtor 102. The risk management network 106 may access and aggregate account data from each of the financial accounts identified as being associated with the debtor 102. This data may be parsed to identify inflow and outflow transactions associated with each financial account. The risk management network 106 may use this data to generate a balance sheet that includes the various inflow and outflow transactions. The risk management network 106 may also access and aggregate data from one or more third party sources 108. For example, personal identifiable information (PII) of the debtor 102 may be matched with information from one or more third party data sources 108 to identify payroll checks/deposits, rent payments, mortgage payments, utility bill payments, and/or other information associated with the debtor 102. This third party information may be reconciled with the account data to categorize various inflows and outflow transactions associated with the debtor 102. Any data from the third party data sources 108 that is already present in the account data from the financial institutions 100 may be marked as already accounted for to prevent the duplicative information from being double counted.

The risk management network 106 may analyze the balance sheet to generate cash flow data that provides a picture of the debtor's financial management and/or general ability to reliably pay for a given loan/line of credit. For example, data generated by the risk management network 106 may include the debtor's average monthly expenses, account status indicators, spending patterns (e.g., frequency, amounts, locations, etc.), outflows to specific payees, average monthly income, recurring monthly expenses, daily account balances, start of month balances, end of month balances, average monthly balance across the one or more financial accounts, highest monthly balance across the one or more financial accounts, lowest monthly balance across the one or more financial accounts, average monthly net cash flow across the one or more financial accounts, and/or other information that may be relevant to determining whether a particular debtor 102 presents a high risk of being unable and/or unwilling to pay off a given loan/line of credit. In some embodiments, the risk management network 106 may use this data to generate a credit/lending risk score, which may be provided to the financial institution 100 associated with the credit/lending request. The financial institution 100 may use the balance sheet, data, and/or credit/lending risk score in place of, or to supplement, a credit score from a credit bureau.

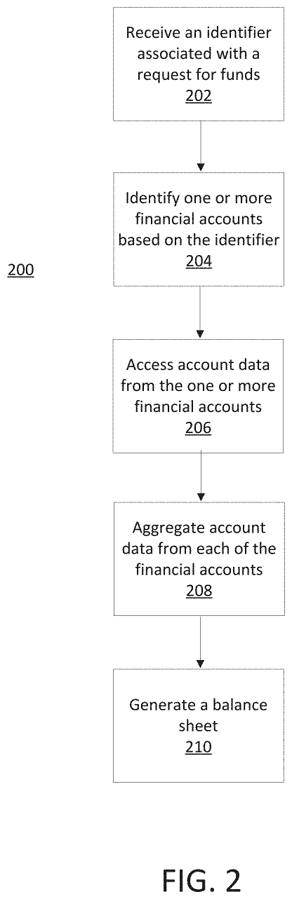

FIG. 2 is a flowchart depicting a process 200 of generating a credit/lending balance sheet according to one embodiment of the present invention. Process 200 may be performed by the risk management network 106. Process 200 may begin at operation 202 by receiving, from a financial institution 100, an identifier associated with a request for funds. For example, the request may be for a loan (secured or unsecured), a line of credit (including a credit card account), a mortgage, and/or other type of borrowed funds. The request may be made by a debtor 102, who may have interacted directly or indirectly with the financial institution 100 in hopes of securing the borrowed funds. For example, in some embodiments the debtor 102 may go to a website and/or a brick and mortar location of a bank or other financial institution to fill out a request for funds, such as an application for a loan or credit account. In other instances, the debtor 102 may attempt to borrow funds from a financial institution 100 indirectly by interacting with a business entity, such as a merchant. For example, the debtor 102 may wish to finance a particular purchase at the merchant and/or open a credit account with the merchant. The merchant may have a relationship with one or more financial institutions 100 that service the potential account. Thus, when the debtor 102 submits an application for the financing and/or credit account, the merchant may submit the request for funds (such as a loan or credit application) to one of the financial institutions 100 for review and an approval decision. Upon receiving the request for funds from the debtor 102 (either directly or indirectly), the financial institution 100 may pass at least some of the information from the request to the risk management network 106. For example, the application for credit/lending funds may include one or more identifiers (such as personal identifiable information (PII)) associated with the debtor 102, as well as an amount of funds requested. At least one identifier from the request may be provided to the risk management network 106.

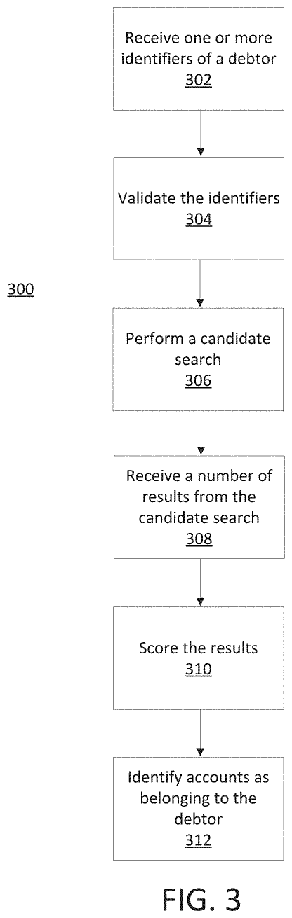

Upon receiving the identifiers associated with the debtor 102 requesting the funds, the risk management network 106 may identify one or more financial accounts associated with a debtor 102 who initiated the request for funds based on the identifier received from the financial institution 100 at operation 204. For example, using the identifier an entity resolution procedure (discussed in greater detail below with respect to FIG. 3) may be performed on one or more pieces of PII data in order to standardize the format of the PII data to look up account identifiers (such as an ABA routing number and/or account number) associated with one or more financial accounts of the debtor 102 across one or more of the financial institutions 100. The risk management network 106 may then access account data from some or all of the identified financial accounts at operation 206. For example, the account data received by the risk management network 106 may include account balance data (e.g., a current balance and/or an average balance over a period of time (such as 30 days, 60 days, 90 days, etc.)) as well as transaction data that details debits and credits associated with each of the financial accounts. In some embodiments, the account data may include information received from one or more third-party sources 108. For example, payroll data, rent data, mortgage data, utility data, and/or other information may be received from one or more third party data sources 108. The third party data may be acquired using a similar entity resolution procedure as the financial account data. The risk management network 106 may aggregate the account data (including the data from third party sources 108 when available) from each of the identified financial accounts at operation 208.

Using the aggregated account data, the risk management network 106 may generate a balance sheet that provides data associated with the income and expenses of the debtor 102 at operation 210. The balance sheet may include account data, such as a total balance across all accounts, account balances for each account, and the like. In embodiments in which data from third party sources 108 is included in the account data, the data from the third party sources 108 may be reconciled with data from the financial institutions 100 to ensure that the information is not double counted and is properly categorized. For example, payroll data may show up in datasets from both a financial institution and a third party payroll source. The risk management network 106 may compare the payroll and other account data to identify deposits that may match a date and/or amount of the payroll data. In some embodiments, a debtor 102 may have payroll checks deposited into multiple accounts. In such embodiments, the risk management network 106 may check for multiple deposits on a same day or within a short range of days of a payroll check identified by a payroll data source.

The risk management network 106 may also analyze the account data to generate cash flow data associated with the financial accounts (collectively and/or individually), which may provide insights on the debtor's earning and spending habits and may serve as a strong indicator of the debtor's ability to afford a given loan and/or line of credit. The cash flow data may be included on the balance sheet in some embodiments. The cash flow data may include average monthly expenses of the debtor 102, an average monthly income of the debtor 102, recurring monthly expenses of the debtor 102, an average monthly balance across the one or more financial accounts of the debtor 102, a highest monthly balance across the one or more financial accounts, a lowest monthly balance across the one or more financial accounts, an average monthly net cash flow across the one or more financial accounts, and/or other data related to cash flow that may impact a lending/credit approval decision. The cash flow data may be organized and/or analyzed for each account and/or collectively to provide indications of the debtor's financial situation.

To generate the cash flow data, the risk management network 106 may analyze the transaction data received from each of the financial accounts. The credits and debits from each financial account may be used to generate an overall cash flow of payments, income, and account balances. In some embodiments, a greater level of detail may be generated, which may provide a better picture of the debtor's overall financial situation. For example, each transaction may include an identifier of another party involved in the transaction and/or an identifier or other indication of a category of a given transaction. This data may be in the form of ACH data, credit card transaction data, and the like. Oftentimes, payroll transaction entries from a given business may include an indication of a source of the payment. For example, all or part of the business name providing the payroll deposit may be included in a transaction entry for a debit or other deposit into a financial account. Similarly, merchant identifiers (e.g., SEC codes, etc.) and/or other destination account identifiers may be used to identify where credits, withdrawals, and payments from the accounts are headed. In some embodiments, the risk management network 106 may also analyze peer to peer payments, such as by using memo information (emoji, notes, etc. that relate to a purpose for a given payment). The risk management network 106 may also identify previous instances of fraudulent transactions associated with one or more of the financial accounts. The risk management network 106 may analyze the identifiers, codes, and/or memos to determine where money transferred from a given financial account was directed. As many of the merchants and/or financial institutions 100 may utilize different codes and/or other identifiers of merchants, destinations, reasons for payment, etc., the risk management network 106 establish databases of the different identifiers/codes and/or analyze numerous codes to improve its ability to properly identify transaction details from transaction data. In some embodiments, the risk management network 106 may include and/or be in communication with a machine learning model that is trained to identify transaction details based on different transaction data.

Based on the nature of the identified merchant (or other destination) and/or other transaction details, the risk management network 106 may be able to categorize a given transaction. For example, a transaction associated with a grocery store may be categorized as a grocery expense, while a transaction associated with an electric company may be categorized as a utility expense. The transactions may be broken up into any number of categories, which may be used to classify expenses of the debtor 102. For example, the expenses over a given time period (such as a week, month, or year) may be grouped by category to provide an overall picture of the debtor's expenses. This may include categorizing expenses as fixed recurring expenses (e.g., car payment, phone bill, mortgage/rent payment, and the like), variable recurring expenses (e.g., utility payments, groceries, etc.), and/or other expenses (e.g., one-time purchases, entertainment costs, dining, travel, etc.). The expenses may also be categorized based on whether the expenses are necessary expenses (e.g., rent/mortgage, car payment, groceries) or optional (e.g., retail spending, entertainment, etc.) to generate a picture of what expenses must be maintained by the debtor 102. By categorizing the expenses (and other transactions), the risk management network 106 may be able to determine whether the debtor's actual cash flow is sufficient to make the debtor 102 a low credit/lending risk to the financial institution 100. For example, if the average net cash flow (and/or other criteria such as net cash flow with essential expenses, etc.) exceeds a monthly payment amount (or some other credit/lending threshold) associated with a given loan or line of credit, then the debtor 102 may be able to afford the requested loan or line of credit and may represent a low credit/lending risk. In some embodiments, the cash flow data may be used in conjunction with average, minimum, and/or other account balances of one or more (or all) accounts of the debtor 102 to determine a lending risk. The balance sheet may be analyzed to determine whether the debtor's assets are sufficient to mitigate any risk associated with cash flow that is near or below the threshold amount. In some instances, the risk management network 106 may determine that even if the net cash flow is below the payment amount of the loan or line of credit, the debtor's monthly recurring expenses are sufficiently low that the debtor's discretionary income may be sufficient to cover the monthly payment amount of the new loan or line of credit. The risk management network 106 may also look at other factors to determine the debtor's creditworthiness. For example, the transaction data may provide insights as to the debtor's payment record with respect to debts and/or other recurring expenses. For example, if the financial accounts of the debtor 102 consistently include records of payments for recurring transactions associated with auto loans, mortgage/rent payments, utilities, and the like, it may be indicative of the debtor 102 being sufficiently responsible to handle the loan or line of credit.

It will be appreciated that the above expense categories and sources, the types of analysis, and techniques for generating credit worthiness decisions are merely provided as examples and that numerous variations exist. For example, categorization of expenses (or income and/or transfers between accounts of the debtor 102) may be broken up into more or fewer categories to meet the needs of a particular application.

In some embodiments, the risk management network 106 may generate a lending score based on the cash flow data and/or the balance sheet. The lending score may be indicative of the debtor's ability and/or willingness to pay for the loan and/or line of credit associated with the request for funds and may be passed to the financial institution 100 associated with the request for funds (possibly along with the balance sheet and/or cash flow data). For example, the risk management network 108 may analyze the timing, number, amount, and/or other characteristics of income and/or expenses within the cash flow data, as well as balance information across one or more accounts (individually and/or collectively) and/or other data to generate a picture of a debtor's ability to afford a particular loan amount. If the net cashflow is above a periodic payment (e.g., monthly payment) associated with the loan amount and/or an average balance across one or more of the accounts indicates that the debtor 102 has sufficient funds to likely afford the loan amount, a lending score reflecting a low risk may be returned. If the net cashflow is below the payment associated with the loan amount and/or an average balance across one or more of the accounts indicates that the debtor 102 does not have sufficient funds to likely afford the loan amount, a lending score reflecting a high risk may be returned. In some embodiments, recurring expense data may be factored into the lending score. For example, if the balance sheet and/or cashflow data reflects that the debtor 102 consistently completed recurring payments, the lending score may be calculated and/or adjusted to indicate that the debtor 102 regularly pays debts, while gaps in recurring payments (e.g., one month includes no payment for rent, car, loan payment, etc.) may indicate that the debtor 102 poses a higher amount of risk of nonpayment, and the lending score may be changed accordingly. Various techniques for generating the lending score may be utilized, and in some embodiments the requesting financial institution 100 may provide the risk management network 108 with customized criteria to generate the lending score to reflect the requesting financial institution's particular risk profile.

In some embodiments, the risk management network 108 may include one or more machine learning models (such as a Gradient Boosted Trees model) that has been trained to generate lending scores based on the probability that a debtor 102 with a given set of balance sheet information and/or cashflow data will present a high risk of default or other nonpayment of a given credit offer. For example, the risk model may be provided with prior balance sheet information and/or cashflow data associated with a number of prior debtors 102 as input variables, along with indications of whether each prior debtor 102 successfully paid off a given line of credit, defaulted, missed payments, and/or had another credit outcome. The risk model may be trained to identify various risk factors (including prior balance sheet information and/or cashflow data such as, but not limited to, net cashflow, average cashflow, average account balances over a given period of time, etc.) that may be indicative of risk for nonpayment of a given amount of credit. The prior balance sheet information and/or cashflow data may be analyzed by the machine learning model in view of whether each prior debtor 102 was associated with a positive or negative lending outcome, enabling the machine learning model to generate a number of sets of risk factors that are indicative of a high risk for a given type, term, and/or amount of credit. When a new debtor 102 is analyzed, the relevant prior balance sheet information and/or cashflow data may be supplied to the machine learning model, which may identify risk associated with the new debtor 102 to determine whether the new debtor 102 is likely to present a risk for a given type, term, and/or amount of credit.

In some embodiments, the risk model may behave deterministically (e.g., an inquiry with the same information scored by the model with the same feature values will always produce the same score). In other embodiments the risk model can be updated/retrained multiple times (e.g., the model can change upon retraining of the model, when the model goes through model governance, and/or when a new version of the model is deployed).

The financial institution 100 may receive the lending score, balance sheet, and/or cash flow data from the risk management network 108 and may use the received data in place of, or to supplement, a conventional credit report when making the decision on whether to approve the debtor's request for funds. The lending score may be a numerical score, a binary rating (e.g., low risk/high risk), a color scale, and/or other mechanism that may provide an indication of the debtor's ability to repay the requested funds. In some embodiments, the lending score may be a standardized score that is used by each of the financial institutions 100, while in other embodiments one or more of the financial institutions 100 may provide specific criteria for the risk management network 106 to use when generating a lending score for that financial institution 100. In some embodiments, the lending score may only be provided to the financial institution 100 associated with the request for funds, while in other embodiments the lending score may also be provided to the debtor 102 associated with the request for funds. In some embodiments, in addition to or in place of the lending score, the risk management network 106 may generate one or more suggested credit limits for the debtor 102 associated with the request. For example, based on the cashflow data (e.g., net cash flow each week, month, and/or other time period) and/or average balances across one or more accounts of the debtor 102, the risk management network 108 may generate one or more suggested credit limits that each indicate a likely amount of total credit and/or periodic (e.g., monthly) payment the debtor 102 may be able to afford. As just one example, if a debtor's monthly cashflow is typically about $150 in the positive, the risk management network 108 may indicate that the debtor 102 may be easily able to afford a credit payment of up to $100, $125, $150, and/or some other value relative to the typical net cashflow. In some embodiments, each suggested credit limit may include a dedicated lending score. In the above example, the lending score for a credit payment of up to $100 may reflect a very low risk, while a credit payment of $125 or $150 may reflect higher risk levels. A credit payment exceeding the typical net cashflow may reflect a very high level of risk. Any number of suggested credit limits and/or associated lending scores may be generated and provided to the requesting institution 100, which may use such information to make an informed credit/lending decision, which may enable more informed decisions to be made as the suggested credit limits and associated lending scores may reflect the debtor's 106 actual ability to pay based on cashflow data. In some embodiments, the risk management network 106 may factor in various information associated with the debtor 102, such as location, cost of living, income brackets, etc. when generating the cash flow data and/or lending score. For example, the risk management network 106 may compare the debtor's balance sheet data (such as, but not limited to, average monthly income and expenses) to census data at one or more levels (e.g., national, regional, state, county, municipality, etc.). Income brackets may further help classify the debtor's spending patterns relative to similarly situated individuals. Such comparisons and analysis may provide additional insights as to a given debtor's ability and willingness to repay a particular debt.

In many cases, a particular debtor 102 may open several different financial accounts across a number of financial institutions 100. In some instances, some or all of the financial accounts may be associated with different debtor identifiers. For example, a user may use his middle name and/or initial when opening one account and may omit the middle name/initial altogether for another account. Debtors may have variations in names based on usage of formal birth names, nicknames, abbreviations, titles, prefixes, suffixes, short form versions of names, and the like. Additionally, there is a possibility that a typographical error may cause the debtor's name and/or other identifying data to be inconsistent across a number of financial institutions 100. Similarly, addresses across one or more financial institutions 100 may be inconsistent, due to abbreviations, typographical errors, failure to update records after the debtor 102 moves, and/or other reasons. The possibility of inconsistencies of various user identifiers may make identifying financial accounts associated with a given debtor 102 quite difficult. Moreover, when identifying accounts associated with a particular debtor 102, there is a need for very high accuracy in ensuring that the identified accounts do, in fact, belong to the debtor 102 associated with a request for funds. Therefore, to increase the likelihood that available financial accounts are identified and accessed, an entity resolution process may be performed.

FIG. 3 is a flowchart illustrating one embodiment of an entity resolution process 300 in accordance with the present invention. Process 300 may be performed by the risk management network 106. For example, process 300 may be performed as part of process 200 described above, and may be used to identify and access financial accounts and/or data from third party data sources 108 associated with the identified debtor 102. Process 300 may begin at operation 302 by the risk management network 106 receiving one or more identifiers (such as PII) of the debtor 102. These identifiers may include, without limitation, the debtor's name, tax payer identifier (including a social security number), business registration and/or tax identifier, driver's license identifier, email address, employer identification number, military identifier, residency and/or citizenship identifier, passport number, registered charity number, residence alien identifier, a state-issued identifier, a student identifier, a voter identification number, a date of birth, an address, a phone number, and/or other identification means. At operation 304, the identifiers may be validated, such as by scrubbing the identifiers for default and incorrect values of various fields. For example, only those identifiers that include a predetermined number of characters in length (e.g., 5 characters), that have a predetermined number of unique characters (e.g., 3 unique characters), and/or having at least one digit (or some other number of digits) may be used to look up the debtor's financial accounts. In some embodiments, one or more additional (or alternative) validation steps may be performed. For example, tax payer identification numbers (TINs) may be scanned for invalid values (e.g., 123456789, 987654321, 00101001, etc.). A TIN may be deemed invalid if all digits are the same, if the first three digits start with a certain sequence (e.g., 000 or 666) and/or satisfies a number of other conditions that may indicate that the TIN is not valid. For phone numbers, the risk management network 106 may remove any non-digit characters (e.g., hyphens, parentheses, periods, etc.), ensure that the phone number matches a pre-determined length (e.g., 10 digits), and/or whether the phone number includes any sequences of digits that are known to be invalid.

After the identifiers have been validated, a candidate search may be performed at operation 306. The candidate search may involve using one or more of the identifiers to search for financial accounts associated with matching identification data. Oftentimes, it may be advantageous to use unique identifiers (e.g., TIN, SSN, etc.) rather than the debtor's name (which may not be unique to the debtor 102) during the candidate search. The risk management network 106 may enter the selected identifier(s) into a search tool that queries one or more databases of financial accounts across one or more financial institutions 100 to generate a list of one or more financial accounts that possibly belong to the debtor 102. In embodiments which a name is used as the identifier, the risk management network 106 may tokenize the name, split the name by spaces, omit any token under a predefined length (such as 2 characters), alias the name tokens, and/or otherwise process the name. For addresses, the risk management network 106 may tokenize the street and split into spaces and/or common address words and/or abbreviations (e.g., street, avenue, road, east, west, etc.) may be removed. In some embodiments a predetermined number of tokens must remain after processing steps for the address to be used in the candidate search.

A number of results from the candidate search may be returned at operation 308. The results may each be associated with a financial account. The results may include any financial accounts and/or third party data entries that are associated with an exact match of a unique identifier. The results may also include other matches. For example, the results may include matches that include names that exhibit a predetermined level of similarity to one or more of the searched identifiers. After identification of results, all (or a predetermined top number) of the results may be scored at operation 310. The scoring may be performed using some or all types of identifiers associated with financial accounts identified in the candidate search. The scoring may include determining whether an account holder name matches the debtor 102. This may include standardizing the name components from account holder names associated with retrieved accounts. For example, the name may be broken down into tokens and non-letter characters may be removed. For each name component (e.g., prefix, given name, family name, suffix, etc.) a lookup may be performed to identify if there are one or more standard forms of the given name component. The lookup may return the original name components, any standardized components (linked by original component), abbreviated forms of any names(de-duplicated), encoded forms of names (de-duplicated), concatenated forms of the original name components (e.g., the name of the debtor 102 as provided in the request for funds), a gender estimation based on the original components provided, and/or other information. For example, if the following name were entered for lookup: “Ms. Debbie Sue Smith Johnson,” the results may include the data in Table 1 below:

TABLE 1

| Original | Standard Form(s) | Abbreviated | Encoded | Concatenated |
|---|---|---|---|---|
| DEBBIE | DEBBIE, DEBORAH | D | TP | |
| SUE | SUE, SUSAN | S | S | DEBBIESUE |
| SMITH | SMITH | S | SM0, XMT | SUESMITH |
| JOHNSON | JOHNSON | J | JNSN, ANSN | SMITHJOHNSON |

Based on such matching techniques, each retrieved name may be scored based on how closely it matches a name included in identification information associated with the request for funds. In some embodiments, each name component may be scored individually, with the individual component scores being combined to generate a match score. For example, an exact match of a given original name component may receive a maximum score, while a match of a standardized component, abbreviated form, encoded form, and/or concatenated form may result in a high, but not maximum score. Each non-original form may be associated with a certainty factor associated with a type of the form that is multiplied to the component score to generate a weighted score. For example, a single-letter abbreviation may have a low certainty factor (such as 0.3), indicating that there is a high degree of uncertainty that the abbreviation (such as “J” for Johnson) corresponds to the intended name match, while the use of an alternate form of a name (such as Susan for Sue) may include a higher certainty factor (such as 0.6). The scores for each name component may be aggregated (such as by summing the weighted scores) to generate an overall name score. Non-name identifiers may be similarly scored, with exact matches getting maximum scores, close matches (such as within one digit) may have moderate scores, and/or larger deviations having low or zero scores. The scores may be weighted and/or added to generate an overall account score.

Once the account score is generated for each result of the candidate search, the overall scores may be compared to a cutoff threshold score to identify matches that are highly likely to belong to the debtor 102. In some embodiments, the financial accounts having scores at or above the threshold score may be analyzed to see if the records meet minimum requirements for a match. For example, a predetermined number of identifiers (such as 3 identifiers) may need to be present in each result. If only the account holder name (or other non-unique identifier) matches the debtor 102, the result may be thrown out due to the uncertainty of the match. If one or more unique identifiers match between a result and the debtor 102, the result may be included as a match. At operation 312, accounts associated with the matches may be identified as belonging to the debtor 102 and/or may be accessed for account data as detailed with respect to process 200 described above.

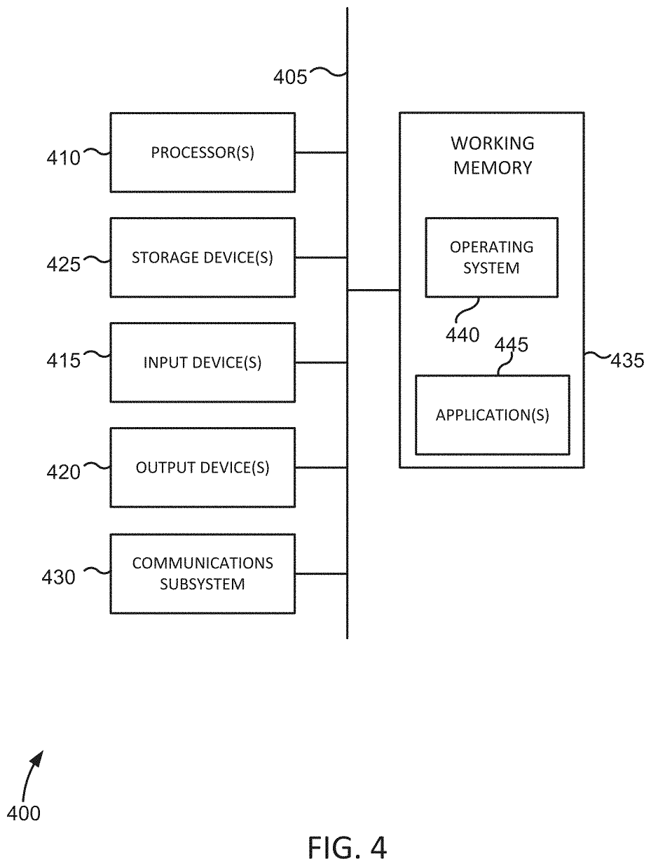

A computer system as illustrated in FIG. 4 may be incorporated as part of the previously described computerized devices. For example, computer system 400 can represent some of the components of computing devices, such as financial institutions 100, user device 102, risk management network 106, third party data sources 108, network 104, and/or other computing devices described herein. FIG. 4 provides a schematic illustration of one embodiment of a computer system 400 that can perform the methods provided by various other embodiments, as described herein. FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include a processing unit 410, including without limitation one or more processors, such as one or more central processing units (CPUs), graphical processing units (GPUs), special-purpose processors (such as digital signal processing chips, graphics acceleration processors, and/or the like); one or more input devices 415, which can include without limitation a keyboard, a touchscreen, receiver, a motion sensor, a camera, a smartcard reader, a contactless media reader, and/or the like; and one or more output devices 420, which can include without limitation a display device, a speaker, a printer, a writing module, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communication interface 430, which can include without limitation a modem, a network card (wireless or wired), an infrared communication device, a wireless communication device and/or chipset (such as a Bluetooth™ device, an 502.11 device, a Wi-Fi device, a WiMAX device, an NFC device, cellular communication facilities, etc.), and/or similar communication interfaces. The communication interface 430 may permit data to be exchanged with a network (such as the network described below, to name one example), other computer systems, and/or any other devices described herein. In many embodiments, the computer system 400 will further comprise a non-transitory working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 425 described above. In some cases, the storage medium might be incorporated within a computer system, such as computer system 400. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 410, applications 445, etc.) Further, connection to other computing devices such as network input/output devices may be employed.

Some embodiments may employ a computer system (such as the computer system 400) to perform methods in accordance with the disclosure. For example, some or all of the procedures of the described methods may be performed by the computer system 400 in response to processing unit 410 executing one or more sequences of one or more instructions (which might be incorporated into the operating system 440 and/or other code, such as an application program 445) contained in the working memory 435. Such instructions may be read into the working memory 435 from another computer-readable medium, such as one or more of the storage device(s) 425. Merely by way of example, execution of the sequences of instructions contained in the working memory 435 might cause the processing unit 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processing unit 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 425. Volatile media include, without limitation, dynamic memory, such as the working memory 435. Transmission media include, without limitation, coaxial cables, copper wire, and fiber optics, including the wires that comprise the bus 405, as well as the various components of the communication interface 430 (and/or the media by which the communication interface 430 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 430 (and/or components thereof) generally will receive the signals, and the bus 405 then might carry the signals (and/or the data, instructions, etc. carried by the signals) to the working memory 435, from which the processor(s) 410 retrieves and executes the instructions. The instructions received by the working memory 435 may optionally be stored on a non-transitory storage device 425 either before or after execution by the processing unit 410.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. These machine-readable instructions may be stored on one or more machine-readable mediums, such as CD-ROMs or other type of optical disks, floppy disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A computerized method of generating a credit/lending balance sheet, comprising:
receiving, from a requesting financial institution, an identifier associated with a request for funds;
identifying one or more financial accounts associated with a debtor who initiated the request for funds based on the identifier;
accessing account data from the one or more financial accounts associated with the debtor;
aggregating the account data from the one or more financial accounts; and
generating a balance sheet from the aggregated account data, the balance sheet providing data associated with income and expenses of the debtor.

2. The computerized method of generating a credit/lending balance sheet of claim 1, wherein:
the debtor comprises an individual or a business entity.

3. The computerized method of claim 1, further comprising:
generating cash flow data associated with the one or more financial accounts.

4. The computerized method of generating a credit/lending balance sheet of claim 3, wherein:
the cash flow data comprises one or more financial metrics of the debtor selected from a group consisting of: average monthly expenses, average monthly income, recurring monthly expenses, average monthly balance across the one or more financial accounts, highest monthly balance across the one or more financial accounts, lowest monthly balance across the one or more financial accounts, and average monthly net cash flow across the one or more financial accounts.

5. The computerized method of generating a credit/lending balance sheet of claim 3, further comprising:
generating a lending score based on the cash flow data.

6. The computerized method of generating a credit/lending balance sheet of claim 1, wherein:
the one or more financial accounts are maintained by a plurality of financial institutions.

7. The computerized method of generating a credit/lending balance sheet of claim 1, wherein:
the one or more financial accounts are selected from a group consisting of: a checking account, a savings account, a brokerage account, and a credit card account.

8. A risk management network, comprising:
one or more processors; and
a memory having instructions stored thereon that, when executed, cause the one or more processors to:
receive, from a requesting financial institution, an identifier associated with a request for funds;
identify one or more financial accounts associated with a debtor who initiated the request for funds based on the identifier;
access account data from the one or more financial accounts associated with the debtor;
aggregate the account data from the one or more financial accounts; and
generate a balance sheet from the aggregated account data, the balance sheet providing data associated with income and expenses of the debtor.

9. The risk management network of claim 8, wherein:
accessing account data from the one or more financial accounts comprises performing an entity resolution process.

10. The risk management network of claim 8, wherein the instructions further cause the one or more processors to:
generate cash flow data associated with the one or more financial accounts; and
generate one or more suggested credit lending limits based at least in part on the cashflow data.

11. The risk management network of claim 10, wherein:
generating the one or more suggested credit lending limits is further based on an average account balance across the one or more financial accounts.

12. The risk management network of claim 10, wherein:
generating the one or more suggested credit lending limits comprises generating a plurality of suggested credit limits; and
each of the plurality of suggested credit limits is associated with different lending score.

13. The risk management network of claim 10, wherein the instructions further cause the one or more processors to:
provide the one or more suggested credit lending limits to the requesting financial institution.

14. The risk management network of claim 8, wherein the instructions further cause the one or more processors to:
generate cash flow data associated with the one or more financial accounts;
generate a lending score based on the cash flow data; and
provide the lending score to the requesting financial institution.

15. A non-transitory computer-readable medium having instructions stored thereon that, when executed by one or more processors, cause the one or more processors to:
receive, from a requesting financial institution, an identifier associated with a request for funds;
identify one or more financial accounts associated with a debtor who initiated the request for funds based on the identifier;
access account data from the one or more financial accounts associated with the debtor;
aggregate the account data from the one or more financial accounts; and
generate a balance sheet from the aggregated account data, the balance sheet providing data associated with income and expenses of the debtor.

16. The non-transitory computer-readable medium of claim 15, wherein: the identifier comprises personally identifiable information data associated with the debtor; and
the personally identifiable information data is used to look up the account data.

17. The non-transitory computer-readable medium of claim 15, wherein the instructions further cause the one or more processors to:
retrieve one or both of income data and expense data from at least one third party data source that is not a financial institution associated with the account data.

18. The non-transitory computer-readable medium of claim 17, wherein:
aggregating the account data from the one or more financial accounts comprises aggregating the one or both of income data and expense data and reconciling the one or both of income data and expense data with the account data to ensure that the one or both of income data and expense data is not doubled counted; and
the balance sheet further comprises the one or both of income data and expense data.

19. The non-transitory computer-readable medium of claim 15, wherein the instructions further cause the one or more processors to:
generate cash flow data associated with the one or more financial accounts;
identify recurring expenses based on the cash flow data; and
generate a lending score based at least in part on the recurring expenses.

20. The non-transitory computer-readable medium of claim 19, wherein the instructions further cause the one or more processors to:
categorize the expenses into a plurality of categories, wherein generating the lending score is based at least in part on the categorized expenses.
